(19) United States
(12) Patent Application Publication
(10) Pub. No.: US 2005/0178563 A1
(43) Pub. Date: Aug. 18, 2005

(54) Horseshoe- and plate-shaped horseshoe made of plastic with lateral supports

(76) Inventor: Karl Rafeld, Wildpoldsried (DE)

Correspondence Address: WILLIAM COLLARD;COLLARD & ROE, P.C., 1077 NORTHERN BOULEVARD, ROSLYN, NY, 11576, US

(21) Appl. No.: 11/004,037

(22) Filed: Dec. 3, 2004

(30) Foreign Application Priority Data
Dec. 4, 2003 (DE) 203 188 20

(51) Int. Cl. A01L 1/00; A01L 3/00; A01L 5/00

(52) U.S. Cl. 168/4

(57) ABSTRACT

Horseshoe- and plate-shaped horseshoe made of plastic, the two legs of which are provided with a device to change the mutual distance between them in the form of a connection bridge permitting adjustment to the size of the hoof. This connection bridge can engage the ends of the legs. The horseshoe has an outside surface provided with projections; supports that are capable of determining the lateral position of the horseshoe in relation to the hoof are provided on the edge of the outside surface. The supports are made of metal and are covered with plastic to at least some extent.

The invention relates to a horseshoe- and plate-shaped horseshoe made of plastic, the two legs of which are provided with a device to change the mutual distance between them in the form of a connection bridge permitting adjustment to the size of the hoof, that can engage the ends of the legs of the horseshoe, where the horseshoe has an outside surface provided with projections and where supports that determine the lateral position of the horseshoe in relation to the hoof are provided on the edge of the outside surface.

Horseshoes of this kind have already been disclosed, for example in WO 02/11533 and EP 893057. The focus in this prior art is on the use of adapters and connecting agents between the two legs of the horseshoe, because relatively simple adjustment is possible to different hoofs with a specific horseshoe size—adjustment in particular to different layers of what is known as the “white line” of the hoof, which alone is available to hold attachment agents, such as horseshoe nails or screws. This means that a specific horseshoe size can be expanded and/or contracted within certain limits in the hoof dimension range by using adapters of different sizes.

In spite of these improvements that are achieved with horseshoes as disclosed in the prior art, which in particular promote the health and efficiency of the legs and/or hoofs of horses, taking particular consideration of the natural hoof function and the anatomical design of the horse's foot, its weight absorption and weight distribution as well as the effects of force and load, further disadvantages need to be eliminated that are attributable to the fact that the supports provided on such plastic horseshoes, that are supposed to make sure the horseshoe fits exactly on the underneath of the hoof and are supposed to facilitate the attachment of the horseshoe to the hoof, can easily be knocked off by the horses provided with such horseshoes, so that although the horseshoe is still secured by the horseshoe nails hammered into the hoof, it loses its lateral stability, particularly when the hoof is subjected to lateral pressure and transverse forces.

The purpose of the invention is therefore to design the plastic supports in such a way that they cannot be torn or knocked off, i.e. so that they maintain their original position on the lateral surface of the hoof.

In the solution to this problem proposed by the invention, the supports are made of metal, are covered with plastic to at least some extent and can be formed plastically against the lateral surface of the hoof.

The supports made of plastic are, so to speak, given a firm metal core as a result and therefore can be neither knocked or torn off easily nor formed only elastically in order to maintain their position on the lateral surface of the hoof; instead of this, they can be formed plastically, because the metal can be shaped accordingly, with the plastic surrounding the metal being formed as well in such a shaping operation without being able to return to its original position.

Advantageous further developments of the invention are characterised in the dependent claims.

It has proved to be very advantageous in this context if the supports have a foot section anchored in the plastic of the horseshoe that is located within the essentially flat surface opposite the outside surface of the horseshoe.

Inadvertent damage to the foot section while the horse is moving is avoided as a result.

In accordance with a further development of the invention, it is also very advantageous if the supports are provided with holes to permit nailing or screwing to the hoof.

This makes it possible to prevent slipping and dislocation of the supports particularly effectively.

It has proved to be extremely advantageous in this context if the holes are located in the foot section of the supports.

The supports can be attached to the hoof together with the horseshoe through these holes.

In another very advantageous development, the foot section has a single-piece, flat design.

Secure attachment of the foot section is made possible as a result.

It has also proved to be very advantageous if the support has a cheek standing upright on the foot section.

Secure attachment of the support to the hoof is guaranteed in this way.

It has also proved to be very advantageous in accordance with the invention if the metal supports can be anchored in the injection mould when the plastic horseshoe is being injection moulded.

This means that a definite position can be specified for the metal part in the plastic.

The invention is explained in greater detail below with reference to the embodiment illustrated in the drawings.

The drawings show:

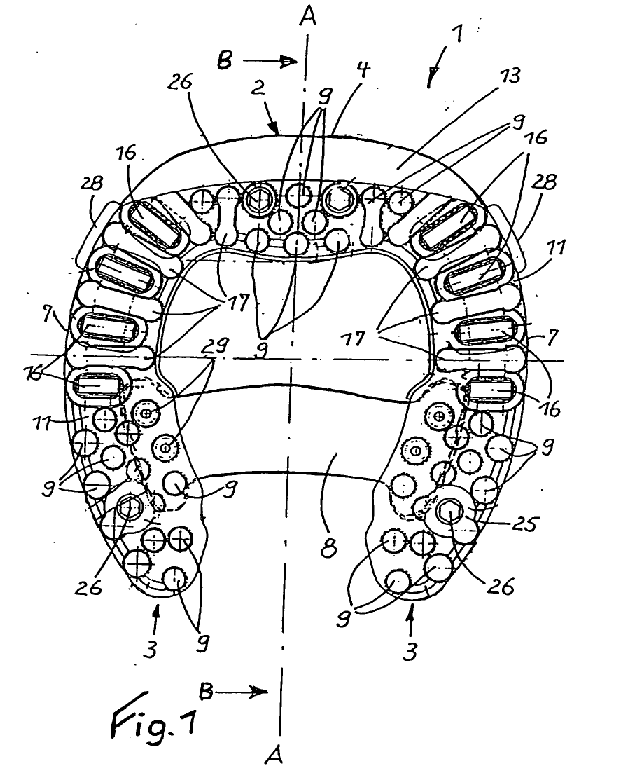

in FIG. 1 a top view of the outside surface of the horseshoe,

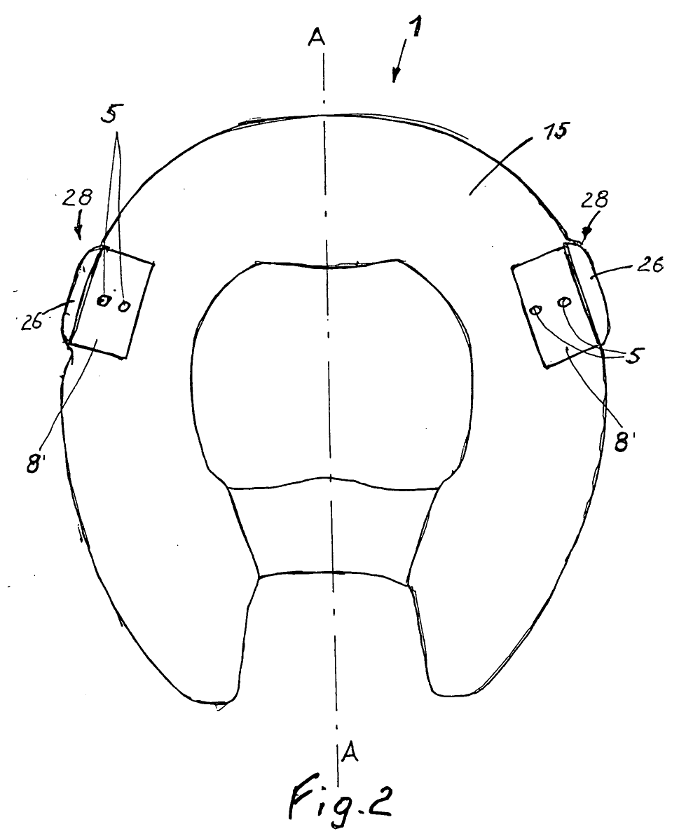

in FIG. 2 a top view of the surface of the horseshoe opposite the outside surface of the horseshoe, in which the foot sections of the supports are embedded,

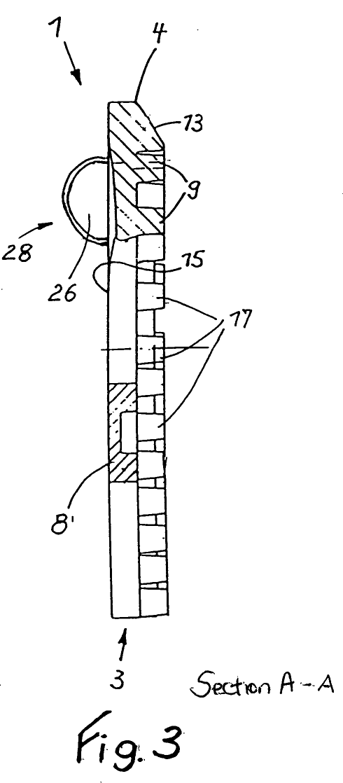

in FIG. 3 a side view of the horseshoe illustrated in FIG. 1 or 2, in the direction of the arrows B-B.

The plate-shaped horseshoe 1 shown in FIG. 1 is made of plastic and basically has the familiar horseshoe-shaped design, i.e. it is provided with two legs 7 as well as a connection bridge 8 that acts as a spacing element between the two legs 7 to change the mutual distance between the ends 3 of them so that they are adapted to the size of the hoof.

The horseshoe 1 has an outside surface 11 with knob-like projections 9. The connection bridge 8 is integrated in the outside surface 11 of the ends of the legs, in order to connect them by what is essentially positive and non-positive locking. At least some of the projections 9 are dumbbell-shaped projections 17, between which oblong recesses 16 are provided, in each of which at least one horseshoe nail (not shown in the drawings) can be located.

As is also shown in FIG. 1, the top section 2 that connects the two legs 7 of the horseshoe 1 has a flattened front edge 4 and an outside surface section 13 on the outside surface 11 of the horseshoe extending essentially to the outside edge of the leg 7 on both sides of the axis of symmetry A-A of the horseshoe, that is free of projections of any kind, particularly knob-shaped projections 9, and has a wedge-shaped cross-section that increases in the direction of the leg ends 3, as can be seen in FIG. 3 in particular. Within the top section 2, the outside surface 11 covered with knob-like projections 9 is provided next to the outside surface section 13 which has no projections.

Knob-like projections 9 are provided on the outside surface 11 in the area of the ends 3 of the legs distributed across the width and length of the legs 7, arranged in such a way that these projections are located following the oblong recesses 16 and dumbbell-shaped projections 17 in the direction of the ends of the legs.

Between the projections identified as 9 and 17, there are several round holes 25 designed to hold studs 26, which are screwed into these round holes when required in order to improve the traction of the horseshoe even more.

The size and width of the horseshoe, i.e. in particular the distance between the legs 7, can be adjusted in what is a basically familiar way with the help of the separate connection bridge 8 or adapter, where the dimensions of the connection bridge are chosen so that the ends 3 of the legs are under tensile stress when the connection bridge is in position, because it has been determined that leg ends under compressive stress can suffer warping or arching of the connection bridge 8 and thus be subject to undesirable material wear, as a result of which the horseshoe—that is generally made of polyurethane—then has to be replaced prematurely.

The connection bridge 8 can, for example, be screwed to the legs 7 or the ends 3 of them, as is indicated by 29 in FIG. 1. The lateral supports 28 on the horseshoe 1 help it to fit properly. The supports 28 are made of metal and are covered in plastic to at least some extent. The metal chosen can be formed cold, i.e. it is pliable, so that the supports 28 allow themselves to be formed plastically against the lateral surface of the hoof as soon as it becomes apparent after lengthy use of the horseshoe that the supports are no longer resting against the lateral surface of the hoof.

As can be seen in FIGS. 2 and 3, the supports 28 have a foot section 8′ anchored in the plastic of the horseshoe 1, which is located within the surface 15 opposite the outside surface 11 of the horseshoe.

The foot section 8′ of the supports 28 is provided with holes 5 to allow it to be nailed or screwed to the hoof. It is practical to anchor the lateral supports in the injection mould when the plastic horseshoe 1 is being injection moulded, so that they are covered with the plastic compound.

The foot section 8′ of the support can in addition have a single-piece, flat design and be structured in such a way that its cheek 26 stands upright on the foot section 8′.

1. Horseshoe- and plate-shaped horseshoe made of plastic, the two legs of which are provided with a device to change the mutual distance between them in the form of a connection bridge permitting adjustment to the size of the hoof, that can engage the ends of the legs of the horseshoe, where the horseshoe has an outside surface provided with projections and where supports that determine the lateral position of the horseshoe in relation to the hoof are provided on the edge of the outside surface, wherein the supports (28) are made of metal, are covered with plastic to at least some extent and can be formed plastically against the lateral surface of the hoof.

2. Horseshoe according to claim 1, wherein the supports (28) have a foot section (8′) anchored in the plastic of the horseshoe (1) that is located within the essentially flat surface (15) opposite the outside surface (11) of the horseshoe.

3. Horseshoe according to claim 1, wherein the supports (28) are provided with holes (5) to permit nailing or screwing to the hoof.

4. Horseshoe according to claim 3, wherein the holes (5) are located in the foot section (8′) of the supports (28).

5. Horseshoe according to claim 2, wherein the foot section (8′) has a single-piece, flat design.

6. Horseshoe according to claim 2, wherein the support has a cheek (26) standing upright on the foot section (8′).

7. Horseshoe according to claim 1, wherein the metal supports (28) can be anchored in the injection mould when the plastic horseshoe (1) is being injection moulded.
